(19) United States
(12) Patent Application Publication
(10) Pub. No.: US 2012/0293626 A1
(43) Pub. Date: Nov. 22, 2012

(54) THREE-DIMENSIONAL DISTANCE MEASUREMENT SYSTEM FOR RECONSTRUCTING THREE-DIMENSIONAL IMAGE USING CODE LINE

(75) Inventors: Suk-Han LEE, Yongin-si (KR); Dae-Sik KIM, Seoul (KR); Yeon-Soo KIM, Seoul (KR)

(73) Assignee: IN-G Co., Ltd., Suwon-si (KR)

(21) Appl. No.: 13/474,203

(22) Filed: May 17, 2012

(30) Foreign Application Priority Data
May 19, 2011 (KR) 10-2011-0047430

(51) Int. Cl. H04N 13/02

(52) U.S. Cl. 348/46; 348/E13.074; 348/E13.003

(57) ABSTRACT

Disclosed herein is a 3D distance measurement system. The 3D distance measurement system includes an image projection device for projecting a pattern image including one or more patterns on a target object, and an image acquisition device for acquiring a projected pattern image, analyzing the projected pattern image using the patterns, and then reconstructing a 3D image. Each of the patterns includes one or more preset identification factors so that the patterns can be uniquely recognized, and each of the identification factors is one of a point, a line, and a surface, or a combination of two or more of a point, a line, and a surface. The 3D distance measurement system is advantageous in that it reconstructs a 3D image using a single pattern image, thus greatly improving processing speed and the utilization of a storage space and enabling a 3D image to be accurately reconstructed.

### CROSS-REFERENCE TO RELATED APPLICATIONS

This application claims the benefit of Korean Patent Application No. 10-2011-0047430, filed on May 19, 2011, in the Korean Intellectual Property Office, the disclosures of which are incorporated herein by reference.

### BACKGROUND OF THE INVENTION

1. Field of the Invention

The present invention relates, in general, to a three-dimensional (3D) distance measurement system and, more particularly, to a 3D distance measurement system which reconstructs a 3D image using a pattern image composed of a plurality of code patterns.

2. Description of the Related Art

Three-dimensional reconstruction technology has been mainly used by experts in the fields of product design and inspection, reverse engineering, image content production, etc. However, recently, with the launching of a satellite image service including a 3D modeling function for urban topography by Google, the average persons' interest in 3D reconstruction technology has increased. In addition, Microsoft is preparing for a new service that extracts 3D information using pictures shared over the Internet and shows an image from any view selected by a user, so that it is expected that demands for 3D reconstruction technology will widen with the popularization of user-created content.

Such 3D reconstruction technology may be divided into a contact type and a non-contact type. Contact type 3D reconstruction denotes a scheme for measuring 3D coordinates in the state in which measurement portions of a target object to be reconstructed are in contact with a measurement sensor. This contact type 3D reconstruction enables high-precision 3D measurement data to be obtained, but makes it impossible to measure an object such as rubber, the shape of which is deformed when pressure is applied. Therefore, as an alternative to this technology, a lot of non-contact type 3D reconstruction technology has been developed. Non-contact type 3D reconstruction is a scheme for measuring the amount of energy reflected from an object or passing through the object and then reconstructing a 3D shape. In this scheme, energy reflected from an object is measured to reconstruct the external shape of the object in a 3D shape; optical methods have been widely used for this in the field of computer vision.

Optical 3D reconstruction methods may be classified into an active method and a passive method according to the sensing method. The active method is a scheme for measuring variations in a pre-defined pattern or sound wave by controlling sensor parameters such as energy, projected on an object, or a focus, thus reconstructing a 3D shape of the object. Representative examples of the active method include a method of projecting structured light or laser light on an object and measuring a variation in phase depending on the distance, a time delay method (time of flight) of measuring the time it takes for a sound wave, which was projected on an object, to be reflected and returned, etc. In contrast, the passive method is a scheme for utilizing the intensity or parallax of an image captured in the state in which energy is not artificially projected on an object. Such a passive method has precision slightly less than that of the active method, but it has the advantages of simplifying equipment and directly acquiring the texture from an input image.

Among optical 3D reconstruction methods, the scheme using structured light, the scheme using 3D laser scanning, and the passive scheme calculate 3D coordinates of a measurement portion using triangulation. That is, intersections of 3D lines passing by a point on a captured image are calculated using the center of a camera (center of projection), so that 3D coordinates of the object are obtained. An active 3D information acquisition technique using structured light estimates a 3D location by continuously projecting coded pattern images using a projector and acquiring an image at a scene on which structured light is projected using a camera. Upon reconstructing 3D information using structured light, various pattern images are used. The number of patterns used at that time is determined depending on the type of coding technique and depending on whether colors have been used. FIG. 1 is a conceptual diagram showing a conventional system for reconstructing a 3D image using structured light.

In general, a 3D image reconstruction system using structured light includes an image projection device for projecting light (a pattern image) and an image acquisition device for acquiring a projected pattern and then reconstructing a 3D image. Such a system is configured such that the image projection device projects a pattern image on a target object, and the image acquisition device acquires the pattern image, analyzes the shapes of deformed patterns on the surface of the object, and reconstructs a 3D image using triangulation. Accordingly, the shapes of the patterns constituting the pattern image and the task of analyzing the patterns necessarily have an influence the accuracy of the system.

When several binary patterns are used, there is the advantage of simplifying the implementation and obtaining a high-resolution depth map, but there is the disadvantage of making it impossible to reconstruct a 3D image when there is a moving object because several pattern images must be continuously projected. Therefore, the use of the conventional 3D image reconstruction method has been limited to just the fields of application such as reverse engineering, 3D modeling, and product inspection which require accurate reconstruction from stationary objects. In order to overcome this disadvantage, the number of pattern images can be reduced using gray or color patterns, but in this case, a problem arises in that errors may be caused due to limited resolution of a depth map and color objects.

### SUMMARY OF THE INVENTION

Accordingly, the present invention has been made keeping in mind the above problems occurring in the prior art, and an object of the present invention is to provide a 3D distance measurement system, which reconstructs a 3D image using a single pattern image, thus greatly improving processing speed and the utilization of a storage space and enabling a 3D image to be accurately reconstructed.

Another object of the present invention is to provide a 3D distance measurement system, which uses a single pattern image, thus enabling a 3D image of a moving target object to be reconstructed in real time.

A further object of the present invention is to provide a 3D distance measurement system, which easily identifies individual patterns, so that accurate information can be obtained, and which sufficiently increases the number of patterns in a pattern image, so that the accuracy and reliability of a 3D image can be improved.

In order to accomplish the above objects, the present invention provides a three-dimensional (3D) distance measurement system, including an image projection device for projecting a pattern image including one or more patterns on a target object; and an image acquisition device for acquiring a projected pattern image, analyzing the projected pattern image using the patterns, and then reconstructing a 3D image, wherein each of the patterns includes one or more preset identification factors so that the patterns can be uniquely recognized by the image acquisition device, and wherein each of the identification factors is one of a point, a line, and a surface, or a combination of two or more of a point, a line, and a surface.

Preferably, the lines of the identification factors may be distinguished from one another depending on line features, and the line features may include one or more of a type, a shape, severing, a length and a location of each line, a shape of a curved line, and a shape of a bent line.

Preferably, surfaces of the identification factors may be distinguished from one another depending on surface features, and the surface features may include one or more of a type, an area, a lateral length, and a vertical length of a figure defined by each surface.

Preferably, the image acquisition device may identify the patterns using one or more of a type, a location, a number and a direction of the identification factors, and an interval between the identification factors.

Preferably, when each of the patterns is divided into branches and a stem, one or more of the branches and the stem may be identification factors. The individual patterns in the pattern image may be identified using one or more of presence or absence of branches, a type, a location, a direction, a number, and a length of the branches, spacing between the branches, severing of the branches or the stem, and colors of the patterns.

Preferably, the patterns may be set such that one or more of locations at which the branches are to be attached to the stem of each pattern, spacing between the branches, and a number of the branches are previously set.

Preferably, the image projection device may generate individual patterns using unique branch codes that are set according to the type of branches, or unique pattern codes that are set according to the type of patterns, and the image acquisition device may identify individual patterns using unique branch codes that are set according to the type of branches, or unique pattern codes that are set according to the type of patterns.

Preferably, when the pattern image includes a plurality of patterns, the pattern image may be constructed using a plurality of pattern combinations in which two or more adjacent patterns are uniquely combined.

Preferably, information about the pattern combinations may be previously stored in the image projection device or the image acquisition device, or generated using combinations of De Bruijn.

Preferably, when the pattern image includes a plurality of patterns, one or more of the plurality of patterns may be arranged to alternate with adjacent patterns.

Preferably, the image projection device may project the pattern image using one or more of visible light, infrared light (IR), and ultraviolet light (UV).

Preferably, the 3D distance measurement system may further include a visible light camera for acquiring an image using visible light in addition to the pattern image when the image projection device projects the pattern image using infrared light or ultraviolet light.

Preferably, the image projection device may include a light source corresponding to any one of a Light Emitting Diode (LED), a Laser Diode (LD), a halogen lamp, a flash bulb, an incandescent lamp, a fluorescent lamp, a discharge lamp, and a special lamp such as a metal halide lamp or a xenon arc lamp.

Preferably, the image projection device may include a pattern image generation unit for generating a pattern image according to a designated algorithm or storing and transferring information about the pattern image. In this case, the image projection device may include one of a Digital Light Processing (DLP) display, a Liquid Crystal Display (LCD), a Liquid Crystal on Silicon (LCoS) display, and a Thin-film Micro-mirror Array actuated (TMA).

Preferably, the image projection device may include a physical filter arranged on a front surface of the image projection device or formed to be integrated with a lens of the image projection device so that a predetermined pattern image is projected through the physical filter. In this case, the physical filter may be produced by forming the pattern image on a film or the lens using printing, photolithography, or laser engraving.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual diagram showing a conventional system for reconstructing a 3D image using structured light;

FIG. 2 is a diagram illustrating examples of identification factors for identifying structured light patterns in a pattern image according to an embodiment of the present invention;

FIG. 3 is a diagram illustrating the shapes of structured light patterns configured using combinations of various lines according to an embodiment of the present invention;

FIG. 4 is a diagram illustrating the shapes of structured light patterns configured using combinations of various lines and various surfaces according to an embodiment of the present invention;

FIG. 5 is a diagram illustrating a method in which an image acquisition device recognizes identification factors constituting each pattern according to an embodiment of the present invention;

FIG. 6 is a diagram illustrating the shapes of structured light patterns constituting a pattern image using a stem and branches according to another embodiment of the present invention;

FIG. 7 is a diagram illustrating a method of constructing a single pattern image using combinations of patterns according to a further embodiment of the present invention;

FIG. 8 is a diagram illustrating a pattern image constructed depending on the arrangement of the pattern combinations of FIG. 7;

FIG. 9 is a diagram illustrating a method of more densely forming an interval between patterns according to yet another embodiment of the present invention; and

FIG. 10 is a block diagram showing the configuration of a 3D distance measurement system capable of reconstructing a 3D image using a code line according to the present invention.

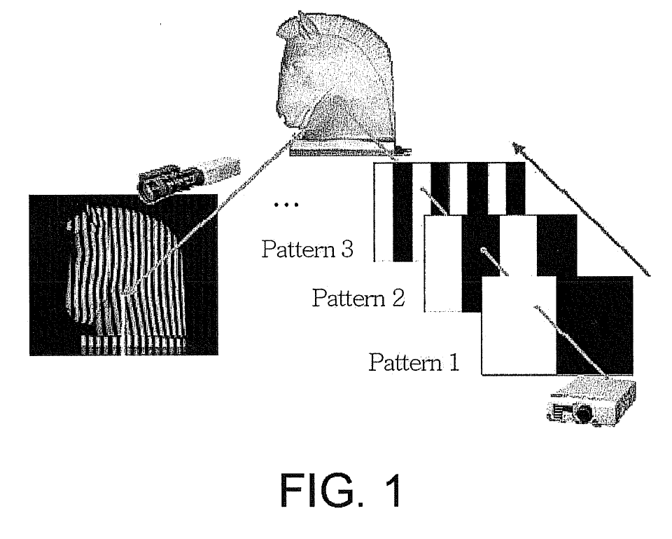

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The present invention can be modified in various manners and can have various embodiments, and specific embodiments of the present invention will be illustrated in the drawings and described in detail in the present specification. However, it should be understood that those embodiments are not intended to limit the present invention to specific embodied forms and they include all changes, equivalents or substitutions included in the spirit and scope of the present invention. If in the specification, detailed descriptions of well-known technologies may unnecessarily make the gist of the present invention obscure, the detailed descriptions will be omitted.

The terms “first” and “second” can be used to describe various components, but those components should not be limited by the terms. The terms are used only to distinguish one component from other components.

The terms used in the present application are only intended to describe specific embodiments and are not intended to limit the present invention. The representation of a singular form includes a plural form unless it definitely indicates a different meaning in context. It should be understood that in the present application, the terms “including” or “having” are only intended to indicate that features, numerals, steps, operations, components and parts described in the specification or combinations thereof are present, and are not intended to exclude in advance the possibility of the presence or addition of other features, numbers, steps, operations, components, parts or combinations thereof.

Hereinafter, embodiments of the present invention will be described in detail with reference to the attached drawings.

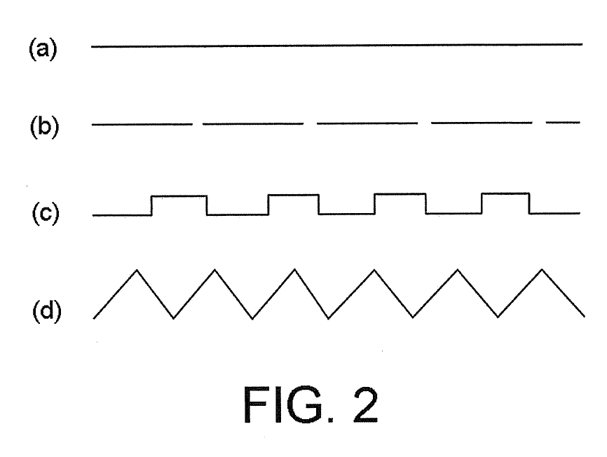

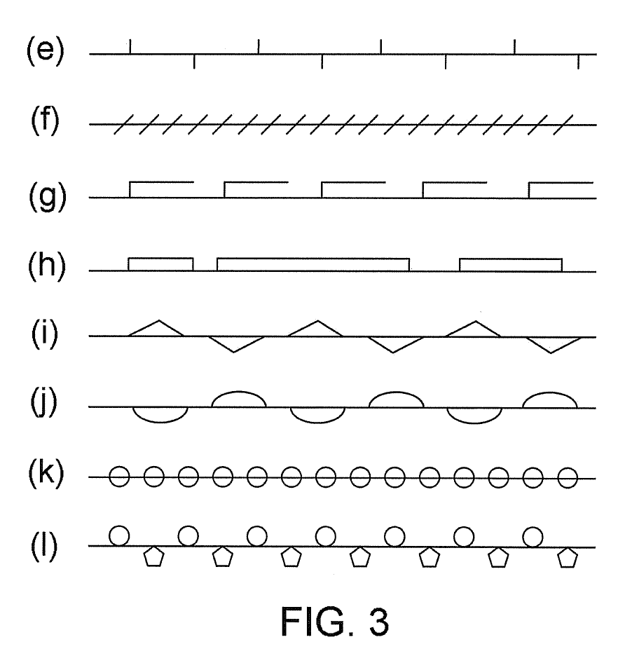

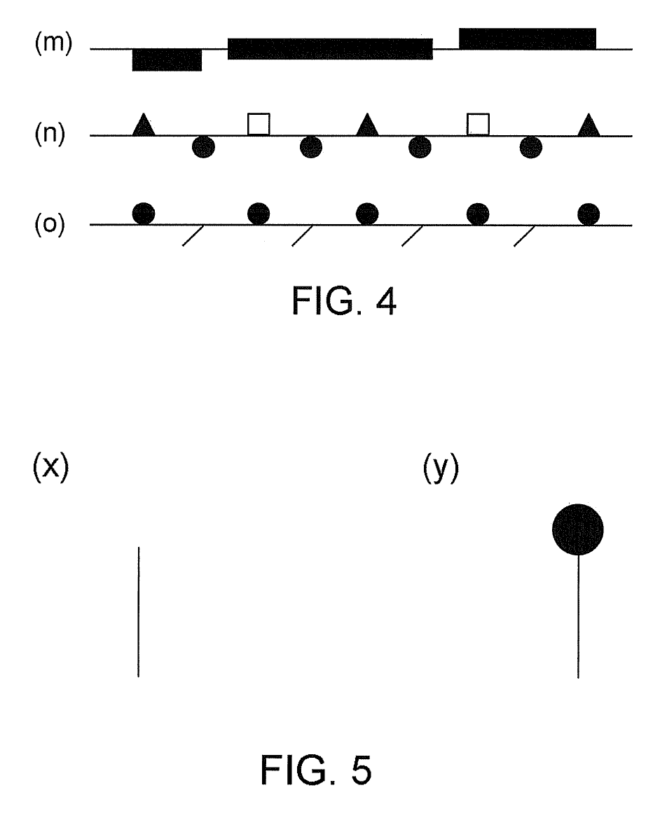

FIG. 2 is a diagram illustrating examples of identification factors for identifying structured light patterns in a pattern image according to an embodiment of the present invention. FIG. 3 is a diagram illustrating the shapes of structured light patterns configured using combinations of various lines according to an embodiment of the present invention. FIG. 4 is a diagram illustrating the shapes of structured light patterns configured using combinations of various lines and various surfaces according to an embodiment of the present invention.

Each pattern in a structured light pattern image according to the present invention includes various preset identification factors so that the patterns can be uniquely recognized by an image acquisition device. Here, the identification factors may be points, various lines, or various surfaces (planes). The image acquisition device can identify individual patterns using one or more of the points, the variety lines and the various surfaces. Of course, it is possible to include a plurality of identical identification factors in a single pattern. That is, the image acquisition device acquires a projected pattern image, separately recognizes individual identification factors constituting a single pattern, or collectively recognizes the individual identification factors, and distinguishes the single pattern from other surrounding patterns based on the results of recognizing the identification factors.

In this case, various lines of the identification factors can be recognized as different identification factors (as different lines) depending on various line features such as the type, shape, severing, length, and location of each line, the shape of a curved line, the shape of a bent line, etc. Here, the types of lines are a solid line, a dotted line, a broken line, a combination of a dotted line, etc., and a broken line, and the shapes of lines are a straight line, a curved line, a bent line, etc.

For example, the image acquisition device according to the present invention can recognize figures (a), (b), (c), and (d) in FIG. 2 as unique identification factors. First, figure (b) has severing unlike figure (a), and figures (c) and (d) have bent portions on lines, unlike figures (a) and (b). In this case, figures (c) and (d) have different bent shapes. Therefore, when the features of these lines are used, figures (a), (b), (c), and (d) can be respectively set as unique identification factors.

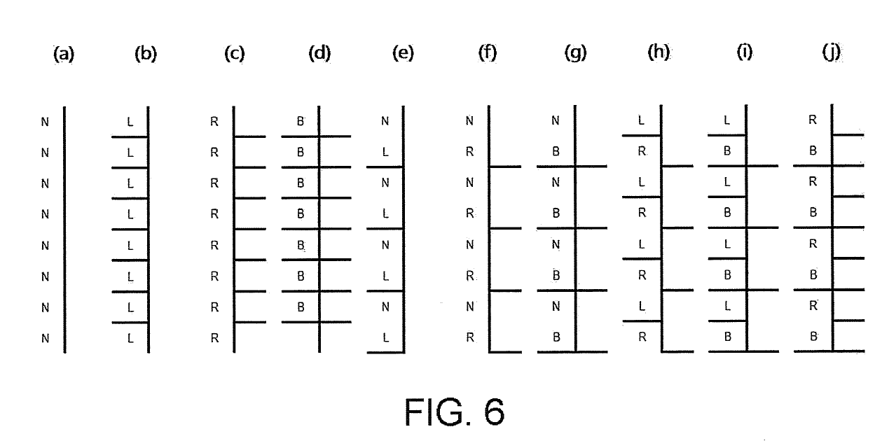

Further, the image acquisition device according to the present invention is capable of identifying individual patterns using combinations of various lines, as shown in FIG. 3, or identifying individual patterns using combinations of various lines and various surfaces, as shown in FIG. 4. Here, various surfaces of identification factors can also be recognized as different identification factors (as different surfaces) using the type, area, lateral length, and vertical length of a figure defined by each surface, etc. Further, the image acquisition device can recognize a wider variety of patterns not only by using the type of identification factors, but also by using the location of identification factors, an interval between the identification factors, the number of identification factors, combinations of patterns, or the like, upon recognizing individual patterns. A detailed configuration related to this will be described in detail with reference to FIGS. 6 to 10.

FIG. 5 is a diagram illustrating a method in which the image acquisition device recognizes identification factors constituting each pattern according to an embodiment of the present invention.

Referring to FIG. 5, the image acquisition device according to the present invention may separately recognize figure (y) as two identification factors or may recognize figure (y) as a single identification factor when identifying figure (x) and figure (y) in FIG. 5. When the image acquisition device recognizes figure (y) as two identification factors, the image acquisition device divides figure (y) into a circle that is an identification factor and a straight line which is another identification factor. Figure (x) and figure (y) can be identified as ‘straight line’ and ‘straight line+circle’, respectively. Alternatively, when the image acquisition device recognizes figure (y) as a single identification factor, the image acquisition device recognizes figure (y) as a lollipop (as an example), and may identify figure (x) and figure (y) as a ‘straight line’ and a ‘lollipop’, respectively.

FIG. 6 is a diagram illustrating the shapes of structured light patterns constituting a pattern image using a stem and branches according to another embodiment of the present invention.

Referring to FIG. 6, according to the present invention, each structured light pattern in the pattern image is divided into a vertical line and lateral lines. For the sake of description, the vertical line is referred to as a ‘stem’, and lateral lines are referred to as ‘branches’. This drawing shows examples when an image projection device and the image acquisition device are disposed in a lateral direction (on left/right sides). When the image projection device and the image acquisition device are disposed in a vertical direction (on upper/lower sides), the patterns are transposed and used. In this case, a lateral line may be referred to as a ‘stem’ and vertical lines may be referred to as ‘branches.’

According to the present invention, on the basis of the overall shape of branches attached to a stem, each stem can be identified. A pattern in which branches are attached to a stem in a specific shape is called a code line. Each structured light pattern according to the present invention can be identified using the presence or absence of branches, the type, location, direction, number, and length (simply, long or short) of branches, spacing between branches, the severing of branches or a stem, or the like. That is, branches or a stem constituting each structured light pattern can be used as identification factors.

For example, in FIG. 6, pattern (a) has no branches. Pattern (b) has only left branches, pattern (c) has only right branches, and pattern (d) has both branches. In the 3D distance measurement system, the image acquisition device recognizes patterns (a), (b), and (c) as different patterns using the presence or absence of branches and the locations of the branches on individual patterns in an image acquired to reconstruct a 3D image, and analyzes the individual patterns projected on a target object.

Further, both patterns (b) and (e) have left branches, but differ from each other in terms of the number of left branches, that is, branches attached to the left side of the stem, and the spacing between the branches. Therefore, the image acquisition device can recognize patterns (b) and (e) as different patterns. Similarly, each of a pattern in which left branches and right branches are alternately attached to the stem (pattern (h)), a pattern in which left branches and both branches are alternately attached to the stem (pattern (i)), and a pattern in which right branches and both branches are alternately attached to the stem (pattern (j)) can be distinguished from the remaining patterns.

Each of the branches of these patterns may have the shape of a diagonal line or a curved line. In the case of a diagonal line, it is also possible to identify a corresponding pattern using an angle that the branch makes with a stem. Further, individual patterns may also be distinguished from each other using the colors of the patterns. For example, when there are two patterns having the same shape: one is yellow and the other is blue, the two patterns having the same shape are recognized as different patterns.

In accordance with an embodiment of the present invention, in order to more effectively use patterns each composed of a stem and branches, unique codes may be assigned to the types of branches and the types of patterns. First, codes for respective branches (hereinafter referred to as ‘branch codes’) may be assigned depending on the presence or absence of branches or the attachment shapes of the branches. For example, in FIG. 6, ‘N’ is assigned to the case where branches are not present, ‘L’ is assigned to the case where left branches are attached, ‘R’ is assigned to the case where right branches are attached, and ‘B’ is assigned to the case where both branches are attached.

In addition, in the case where diagonal branches are used, ‘U’ is assigned to the case of diagonally rising branches, and ‘D’ is assigned to the case of diagonally falling branches. In the case where the colors of patterns are used, codes may be assigned in such a way as to assign ‘y’ to the case of yellow branches, ‘b’ to the case of blue branches, and ‘r’ to the case of red branches. However, in FIG. 6, only codes L, R, B and N are illustrated and described.

Here, the number of branches that can be attached to a single stem, the locations of the branches, or spacing between the branches can be previously set. In FIG. 6, it is assumed that eight branches are attached to a single stem at regular intervals. Branch codes for respective patterns in FIG. 6 are determined as given in the following Table 1.

When the number of branch types is p and the number of branches that can be maximally attached to a single stem is m, the number of identifiable patterns that can be generated from the branches and the stem is p^{m}. For example, as shown in FIG. 6, when the number of branch types is set to four (N, L, R and B), and the number of branches that can be maximally attached to a single stem is set to eight, the number of pattern types that can be generated from the branches and the stem is 8⁴(=4096).

TABLE 1
Branch codes and pattern codes for respective patterns of FIG. 6

| Pattern | Branch code | | | | | | | | Pattern code |
|---|---|---|---|---|---|---|---|---|---|
| (a) | N | N | N | N | N | N | N | N | NN |
| (b) | L | L | L | L | L | L | L | L | LL |
| (c) | R | R | R | R | R | R | R | R | RR |
| (d) | B | B | B | B | B | B | B | B | BB |
| (e) | N | L | N | L | N | L | N | L | NL |
| (f) | N | R | N | R | N | R | N | R | NR |
| (g) | N | B | N | B | N | B | N | B | NB |
| (h) | L | R | L | R | L | R | L | R | LR |
| (i) | L | B | L | B | L | B | L | B | LB |
| (j) | R | B | R | B | R | B | R | B | RB |

Generally, a single pattern image includes a large number of patterns, and a much larger number of patterns are required so as to reconstruct a target object at higher resolution. In accordance with another embodiment of the present invention, a single pattern image can be constructed using a smaller number of pattern types. Two, three or more adjacent patterns are combined, and combinations of unique patterns are continuously arranged in a single pattern image, so that the pattern image can be constructed using a much smaller number of pattern types compared to a pattern image that is constructed using different pattern types. In this case, in order to identify a single pattern, a separate short pattern code rather than a long code sequence such as branch codes can be used. Table 1 shows that not only branch codes corresponding to 10 patterns shown in FIG. 6, but also unique pattern codes for the respective patterns, are listed for the 10 patterns.

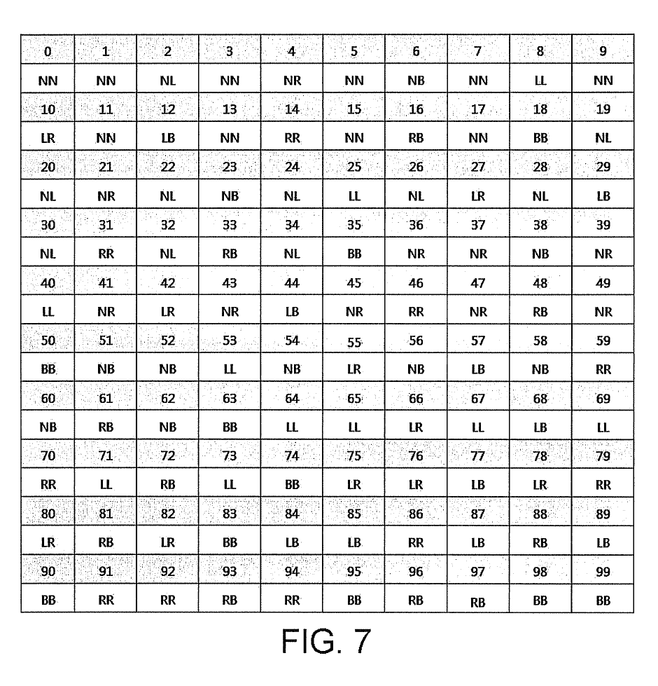

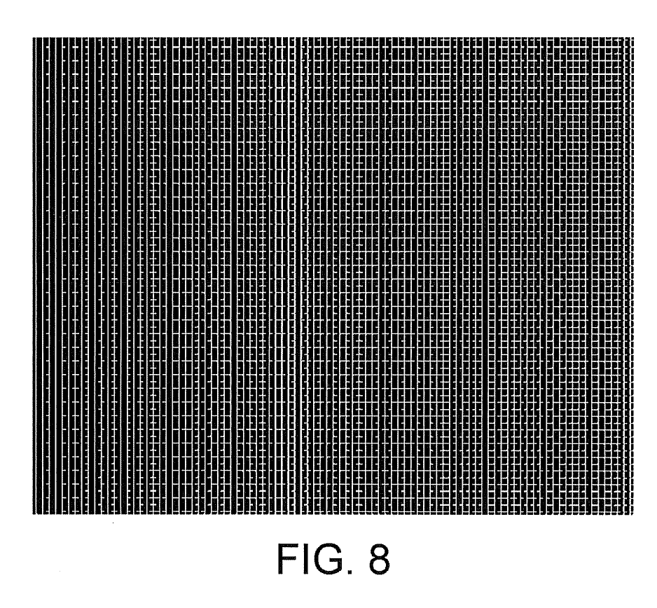

For example, FIG. 7 is a diagram illustrating a method of constructing a single pattern image using combinations of patterns according to a further embodiment of the present invention, and FIG. 8 is a diagram illustrating a pattern image constructed depending on the arrangement of the pattern combinations of FIG. 7.

Referring to FIG. 7, a single pattern image is composed of 100 patterns, and 10 basic patterns (hereinafter referred to as ‘base patterns’) are used so as to construct the corresponding pattern image. Here, base patterns are 10 patterns shown in FIG. 6, and pattern codes corresponding to respective base patterns are shown in Table 1. In FIG. 7, the sequence of arrangement of individual patterns (No. 0˜99) in the pattern image and patterns codes corresponding to the respective patterns are shown. As a whole, a single pattern code is used several times, but when a combination of each pair of patterns is separately considered, the same pattern combinations are not discovered. That is, in a single pattern image, two adjacent patterns are arranged as a unique combination (hereinafter referred to as a ‘pattern combination’). For example, in FIG. 7, the 0-th pattern code is ‘NN’ and the 1st pattern code is ‘NN’, but combinations of any two adjacent patterns except for the combination of the 0th and 1st pattern codes do not exhibit a combination of ‘NN’ and ‘NN’ in the pattern image of FIG. 7.

If it is assumed that n base patterns are present, and pattern combinations are generated using k adjacent patterns including a relevant pattern, the number of possible pattern combinations is n^{k}. That is, as shown in FIG. 7, when n is 10 and k is 2, 10²=100 unique pattern combinations can be generated. On the contrary, in order to generate 64 patterns, eight base patterns are required when two adjacent patterns are used (8²=64), and four base patterns are required when three adjacent patterns are used (4³=64). When pattern combinations are used, the number of pattern types used to construct a single pattern image is greatly reduced, and the length of pattern codes required to identify each pattern is also shortened, so that the system can easily process information, and the processing speed thereof can be greatly improved. These pattern combinations are previously set by the user and then stored, or are generated using combinations of De Bruijn. In addition, various methods for combining base patterns so as to obtain unique pattern combinations can be utilized.

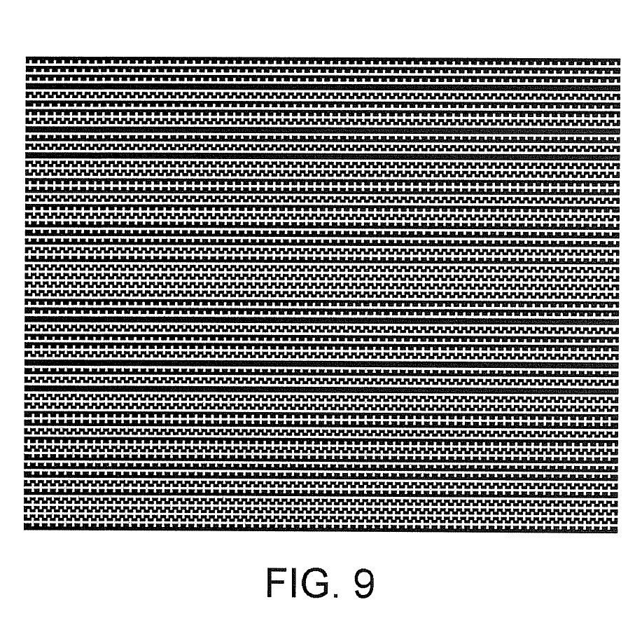

FIG. 9 is a diagram illustrating a method of more densely forming an interval between patterns according to a further embodiment of the present invention.

FIG. 9 illustrates the case where the image projection device and an image acquisition device are disposed in a vertical direction (upper/lower sides), and corresponds to the case where the patterns of FIG. 8 are transposed. Referring to FIG. 9, individual patterns in a pattern image are arranged to alternate with adjacent patterns, and thus it can be seen that patterns are arranged more densely, in other words, that a much larger number of patterns are arranged in the pattern image. The number of patterns constituting a single pattern image is proportional to the amount of information about a 3D image. Therefore, as shown in FIG. 9, when patterns are densely arranged, the image acquisition device can acquire more information about a target object from an acquired image, and it is possible to more precisely reconstruct a 3D image using the acquired information.

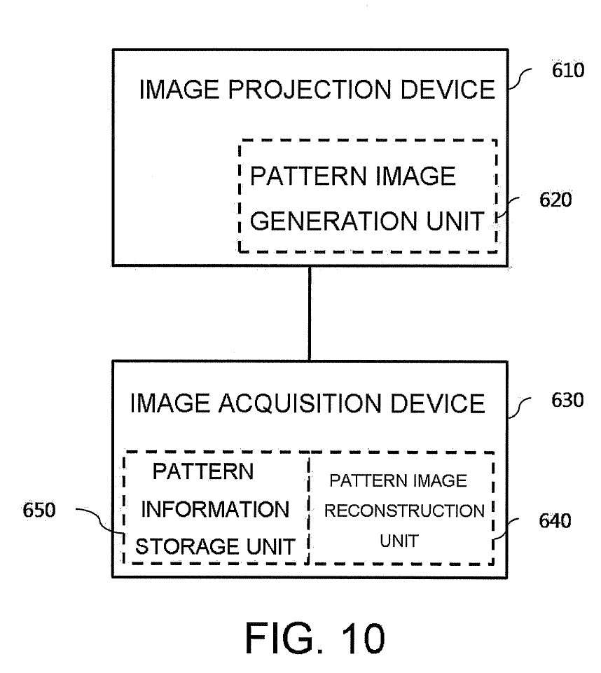

FIG. 10 is a block diagram showing the configuration of a 3D distance measurement system capable of reconstructing a 3D image using a code line according to the present invention.

Referring to FIG. 10, the 3D distance measurement system includes an image projection device 610 and an image acquisition device 630. In this case, the image projection device 610 projects a pattern image generated using code lines, and the image acquisition device 630 acquires an image on which the pattern image has been projected, identifies each pattern using code lines or pattern combinations, and then reconstructs a 3D image. In this case, the code lines or the method of constructing the pattern image using the code lines has been described with reference to FIGS. 6 to 9, and thus a description thereof is omitted here.

In order for the image projection device 610 to project a pattern image, a physical filter may be arranged on the front surface of the image projection device 610 on which light is projected so that only a relevant pattern image is projected through the physical filter, or alternatively, a pattern image generation unit 620 for generating a pattern image may be provided in the image projection device 610. In this case, the physical filter arranged on the front surface of the image projection device 610 may be formed to be integrated with the lens of the image projection device 610. The physical filter may be produced by forming the pattern image on a film or a lens using a method such as printing, photolithography, or laser engraving. Further, the pattern image generation unit 620 may function to generate the pattern image depending on a designated algorithm, or to simply sequentially store pieces of information about the pattern image and to sequentially transfer the pieces of information. When the pattern image is generated by the pattern image generation unit 620, the image projection device 610 may be implemented as a Digital Light Processing (DLP) display, a Liquid Crystal Display (LCD), a Liquid Crystal on Silicon (LCoS) display, or a Thin-film Micro-mirror Array actuated (TMA).

Further, the image acquisition device 630 includes a pattern information storage unit 640 for storing information required to identify individual patterns so as to identify individual patterns from the acquired image, and a pattern image reconstruction unit 650 for identifying the individual patterns from the acquired image and reconstructing a 3D image using the identified patterns. Here, the pattern information storage unit 640 and the pattern image reconstruction unit 650 may be implemented as devices separately from the image acquisition device 630. Furthermore, information required to identify patterns used by the image projection device 610 or the image acquisition device 650 may include branch codes, pattern codes, etc.

Meanwhile, the wavelength bands of projected light that is used by the image projection device 610 may be various bands, such as a visible light band, an infrared light (IR) band, or an ultraviolet light (UV) band. Generally, the 3D distance measurement system includes a single image projection device 610 and a single image acquisition device 630. If the image projection device 610 projects a pattern image using light present in a wavelength band other than a visible light band, the 3D distance measurement system may further include a separate image acquisition device (for the visible light band, not shown) to acquire images in the visible light band.

Further, the light source of the image projection device 610 may be implemented using various light sources such as a Light Emitting Diode (LED), a Laser Diode (LD), a halogen lamp, a flash bulb, an incandescent lamp, a fluorescent lamp, a discharge lamp, and a special lamp (a metal halide lamp, a xenon arc lamp, or the like).

As described above, the 3D distance measurement system according to the present invention is advantageous in that it reconstructs a 3D image using a single pattern image, thus greatly improving processing speed and the utilization of a storage space and enabling a 3D image to be accurately reconstructed.

Further, the 3D distance measurement system according to the present invention is advantageous in that it uses a single pattern image, thus enabling a 3D image of a moving target object to be reconstructed in real time.

Furthermore, the 3D distance measurement system according to the present invention is advantageous in that it easily identifies individual patterns, thus obtaining accurate information, and it sufficiently increases the number of patterns in a pattern image, thus improving the accuracy and reliability of a 3D image.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A three-dimensional (3D) distance measurement system, comprising:
an image projection device for projecting a pattern image including one or more patterns on a target object; and
an image acquisition device for acquiring a projected pattern image, analyzing the projected pattern image using the patterns, and then reconstructing a 3D image,
wherein each of the patterns includes one or more preset identification factors so that the patterns can be uniquely recognized by the image acquisition device, and
wherein each of the identification factors is one of a point, a line, and a surface, or a combination of two or more of a point, a line, and a surface.

2. The 3D distance measurement system according to claim 1, wherein:
lines of the identification factors are distinguished from one another depending on line features, and
the line features include one or more of a type, a shape, severing, a length and a location of each line, a shape of a curved line, and a shape of a bent line.

3. The 3D distance measurement system according to claim 1, wherein:
surfaces of the identification factors are distinguished from one another depending on surface features, and
the surface features include one or more of a type, an area, a lateral length, and a vertical length of a figure defined by each surface.

4. The 3D distance measurement system according to claim 1, wherein the image acquisition device identifies the patterns using one or more of a type, a location, a number and a direction of the identification factors, and an interval between the identification factors.

5. The 3D distance measurement system according to claim 2, wherein when each of the patterns is divided into branches and a stem, one or more of the branches and the stem are identification factors.

6. The 3D distance measurement system according to claim 5, wherein the individual patterns in the pattern image are identified using one or more of presence or absence of branches, a type, a location, a direction, a number, and a length of the branches, spacing between the branches, severing of the branches or the stem, and colors of the patterns.

7. The 3D distance measurement system according to claim 5, wherein the patterns are set such that one or more of locations at which the branches are to be attached to the stem of each pattern, spacing between the branches, and a number of the branches are previously set.

8. The 3D distance measurement system according to claim 6, wherein the image projection device generates individual patterns using unique branch codes that are set according to the type of branches, or unique pattern codes that are set according to the type of patterns.

9. The 3D distance measurement system according to claim 6, wherein the image acquisition device identifies individual patterns using unique branch codes that are set according to the type of branches, or unique pattern codes that are set according to the type of patterns.

10. The 3D distance measurement system according to claim 1, wherein when the pattern image includes a plurality of patterns, the pattern image is constructed using a plurality of pattern combinations in which two or more adjacent patterns are uniquely combined.

11. The 3D distance measurement system according to claim 10, wherein information about the pattern combinations is previously stored in the image projection device or the image acquisition device, or generated using combinations of De Bruijn.

12. The 3D distance measurement system according to claim 1, wherein when the pattern image includes a plurality of patterns, one or more of the plurality of patterns are arranged to alternate with adjacent patterns.

13. The 3D distance measurement system according to claim 1, wherein the image projection device projects the pattern image using one or more of visible light, infrared light (IR), and ultraviolet light (UV).

14. The 3D distance measurement system according to claim 13, further comprising a visible light camera for acquiring an image using visible light in addition to the pattern image when the image projection device projects the pattern image using infrared light or ultraviolet light.

15. The 3D distance measurement system according to claim 1, wherein the image projection device comprises a light source corresponding to any one of a Light Emitting Diode (LED), a Laser Diode (LD), a halogen lamp, a flash bulb, an incandescent lamp, a fluorescent lamp, a discharge lamp, and a special lamp such as a metal halide lamp or a xenon arc lamp.

16. The 3D distance measurement system according to claim 1, wherein the image projection device comprises a pattern image generation unit for generating a pattern image according to a designated algorithm or storing and transferring information about the pattern image.

17. The 3D distance measurement system according to claim 16, wherein the image projection device comprises one of a Digital Light Processing (DLP) display, a Liquid Crystal Display (LCD), a Liquid Crystal on Silicon (LCoS) display, and a Thin-film Micro-mirror Array actuated (TMA).

18. The 3D distance measurement system according to claim 1, wherein the image projection device comprises a physical filter arranged on a front surface of the image projection device or formed to be integrated with a lens of the image projection device so that a predetermined pattern image is projected through the physical filter.

19. The 3D distance measurement system according to claim 18, wherein the physical filter is produced by forming the pattern image on a film or the lens using printing, photolithography, or laser engraving.
